(19) United States
(12) Patent Application Publication
(10) Pub. No.: US 2014/0365257 A1
(43) Pub. Date: Dec. 11, 2014

(54) COMPUTER AIDED TRACKING BY BIOMETRICS

(71) Applicant: Government Utilities Technology, Inc., Thorntown, IN (US)

(72) Inventors: Eric V. Goodnight, Thorntown, IN (US); Grant D. Goodnight, Lebanon, IN (US); Aaron Gold, Westfield, IN (US); Curtis Grasso, Fishers, IN (US)

(21) Appl. No.: 14/296,742

(22) Filed: Jun. 5, 2014

Related U.S. Application Data
(60) Provisional application No. 61/832,507, filed on Jun. 7, 2013.

(51) Int. Cl. G06Q 10/06

(52) U.S. Cl. CPC G06Q 10/063114
USPC 705/7.15

(57) ABSTRACT

A computer aided method of racking persons who need to be tracked, comprising the steps of providing means to biometrically identify and track the movements of persons to be tracked; providing business rules and business rule monitoring to assure that persons tracked movements are completed correctly and timely; providing wizard-based computer data entry of persons' tracking data; providing alert notifications by e-mail and by text messaging relating to persons being tracked; providing cloud-based computer data sharing relating to persons being tracked; providing mobile dashboard integration of data relating to persons being tracked; and providing real-time transaction logging of persons' tracking data.

### BACKGROUND OF THE INVENTION

Almost all Jail and/or Prison facilities face litigation from detainees who are exploiting poor or inaccurate record keeping by these facilities. These claims can range anywhere from a detainee claiming to having been placed into a location he or she was not supposed to go, to claiming that the detainee was not given a meal on a certain day. Most facilities will task their staff member with tracking these activities on a piece of paper or by entering their transactions into their Jail Management System long after the fact. In most cases, this causes data to not be tracked or causes inaccurate tracking data to be entered, which in turn does not allow the facility to present a reliable or credible case in a court of law. Most times this causes the facility to settle the court case out of court, costing taxpayers and insurance companies lots of money.

Along with litigation comes a concern about staff management. In most cases, since poor record keeping is being done, it is very hard for management to determine if a staff member is engaged in something he or she should not be doing. The current structures allow for records to be altered or to not be submitted at ail, which makes management and consequent successful litigation impossible.

### SUMMARY OF THE PRESENT INVENTION

The present invention solves the above problems. It was originally designed to be installed within correctional facilities, however the inventive process is transferrable to other types of facilities in which individual movements must me tracked, such as in nursing homes, juvenile centers, and mental health care facilities, for examples.

The present invention developed and combined the seven different methodologies described below, which all work together within the present invention to solve the above stated management and litigation problems.

1. Biometric Tracking—Biometric tracking, preferably through fingerprints, is used by the present invention to achieve a couple of things. First it gives the ability to quickly and accurately identify a detainee or staff member, rather than relying on a staff member to pick the correct detainee from a list. Biometrics are used to track detainee movements throughout the facility, as well as to allow a staff member to log into the system without the need to type in the staff member's password.

2. Business Rule Monitoring—Business rules are required to assure certain processes are being completed and within an allotted amount of time within any facility. Business rules for a facility could slightly change from one facility to another, so the business rules need to be customizable. The present invention allows facilities to create and modify business rules, including scheduling various events, movement times and tasks within the system to achieve what is best for a facility.

3. Wizard Based Data Entry—Data entry via a wizard approach allows for fewer errors during data entry and provides a platform for simple business rule execution. Wizard-based approaches also keep interface design simple and easy to use, creating much easier raining scenarios and lowering the learning curve of new users.

4. Alert Notifications—The present invention is capable of sending alert notifications by email and by text messaging. These alerts are triggered from various events within the system and are sent to supervisors for review.

5. Cloud Based Data Sharing—The present invention utilizes a cloud-based infrastructure to share data amongst different facilities. Data sharing allows the applications to search information from other facilities and to perform various business rule functions based on that information.

6. Mobile Dashboard Integration—The present invention utilizes mobile smartphone technology to allow supervisors to be connected while on the go. Through the use of a mobile dashboard application, a supervisor can monitor tracked activities and address issues before they occur.

7. Real-time Transaction Logging—The present invention logs tracking transactions in real-time. Supervisors no longer have to worry about inaccurate or late dated information. All actions done within the system are logged in as they are being done.

### BRIEF DESCRIPTION OF THE FIGURES

FIG. 1 illustrates a sample flow chart of a detainee's tracked entry into a detention facility in a preferred embodiment of the present invention.

FIG. 2 illustrates the several different architectural layers of the software utilized in a preferred embodiment of the present invention.

FIG. 3 illustrates the cloud-based data sharing topology utilized in a preferred embodiment of the present invention.

FIGS. 4 & 5 illustrate typical detainee movements that are tracked in a preferred embodiment of the present invention.

### DETAILED DESCRIPTION OF THE INVENTION

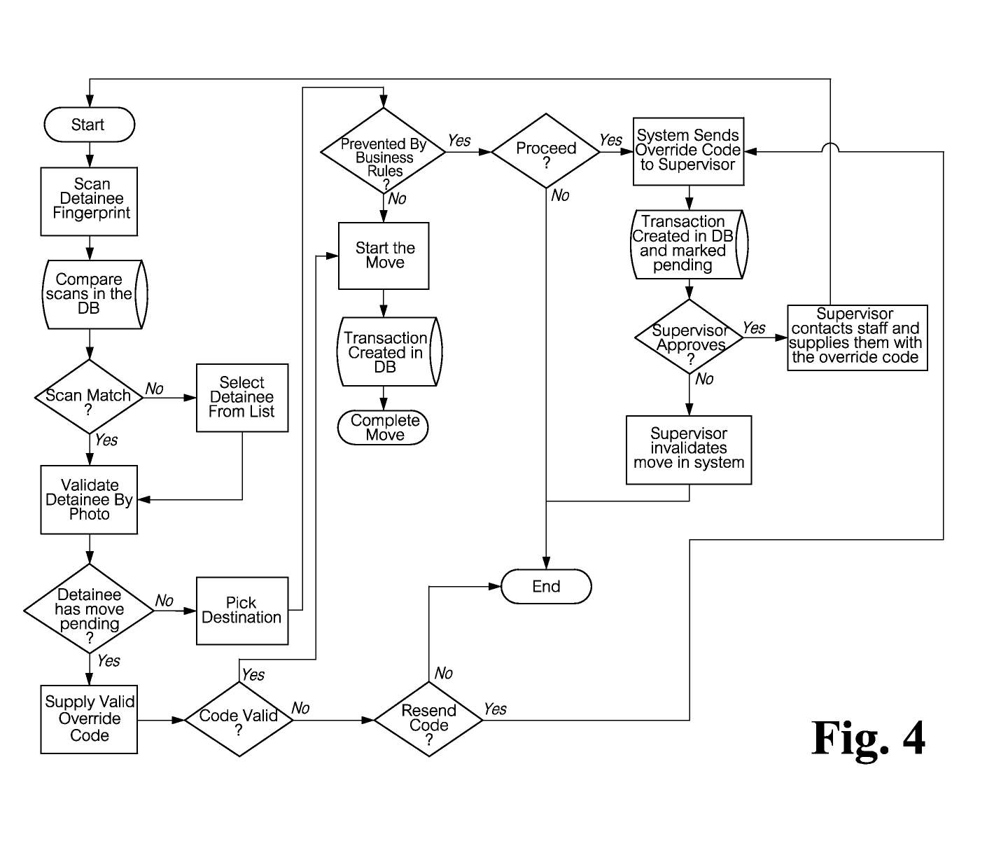

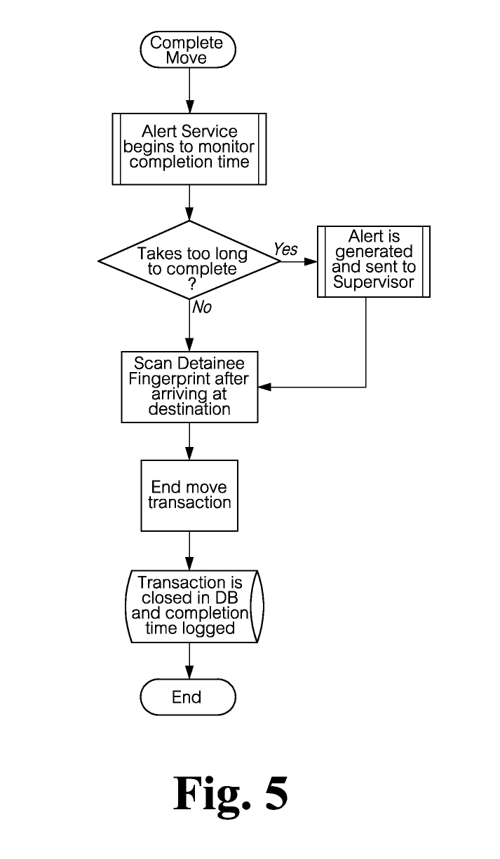

The most powerful aspect of the present invention is tracking detainee movements, which is flowcharted in FIGS. 4-5. A detainee is moved from point A to point B, such as from a cell block to a recreation area, or from a cell block to an infirmary, etc. The amount of travel time required for a given task changes within each facility, and business rules for these travel times are established for each facility for moving someone from point A to point B. The first thing staff member must do is to physically retrieve the detainee and then log into the system, which preferably is done at a kiosk located on a nearby wall. The detainee's fingerprint is read by the preferred biometric tracking device on the kiosk and is used to obtain the identity of the detainee in the first step of the present invention. If no identity can be obtained by fingerprinting, then a detainee selection list is provided by the present invention (all methods of detainee selection are tracked and the staff member is then able to confirm the identity of the detainee via a photograph of the selected detainee on a kiosk screen.

The current location of a detainee is always known by the present invention, so the staff member now must select where they are taking the detainee, and a movement transaction is created. This transaction will show who is being moved, where they are going, who is moving them, how long it has been since the transaction started, and a location identification of the machine used to start the transaction. This allows supervisors to validate tasks their staff members are performing as well as to validate a detainee's movements between locations, Le. that they are not to be in locations where they do not belong.

The present invention also has business rules that define room classifications and lists of other detainees that cannot be allowed to occupy the same space (i.e., keep them separated). If a user attempts to start a move transaction that will break one of these business rules, an override notification is sent to the supervisor with an alert code. The supervisor must then contact the user with that code or the transaction will not be allowed to continue within the system.

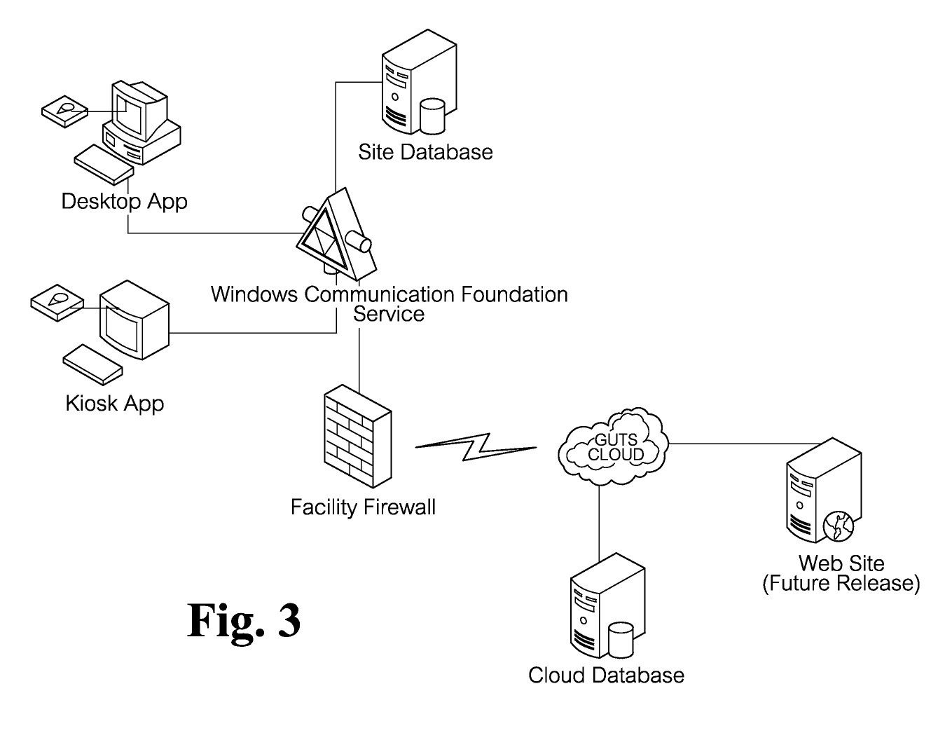

The keep-separated list is a great example of when the cloud-based data sharing of the present invention comes in handy. The cloud gives the staff member the ability to store information from all related facilities using the present invention and to share that information with all related facilities. So, if a detainee is not allowed to be with a certain detainee, then all locations will have access to that information. This aids related facilities in avoiding potential issues by commingling keep-separated detainees. The application topology is shown in FIG. 3.

Going back to the foregoing transaction, assuming the transaction was allowed to be started, the staff member would escort the detainee o the desired location. Once in that desired location, the staff member would log into a kiosk location on a nearby wall, and re-finger print the detainee to validate their arrival at the desired location. Once the detainee's presence has been logged into the system at the new location, the system shows the detainee in the new location and no longer in movement. The process is then repeated to move the detainee back to the first location, or to another location.

If during the movement transaction one does not complete it in the allotted time, say within 5 minutes, then an alert notification is sent to a supervisor alerting them there might be a problem they need to address. An alert service is constantly monitoring all event types to determine if an alert is necessary or not, This allows a supervisor to address issues right away rather than finding out about them at a later date.

The present invention also handles other events, such as suicide Watches, for example. An event can be set to be a one-time event, or a recurring event. Each event then can be set for allotted completion time. As with detainee movement, the alert service monitors events to validate the associated business rules and then determines if an alert is necessary.

Handling tasks is another component of the present invention's software. Tasks are items that are done periodically, nut are not necessarily tied to business rules such as room checks, for example. These items are just simply logged in as being completed in the system with notes attached.

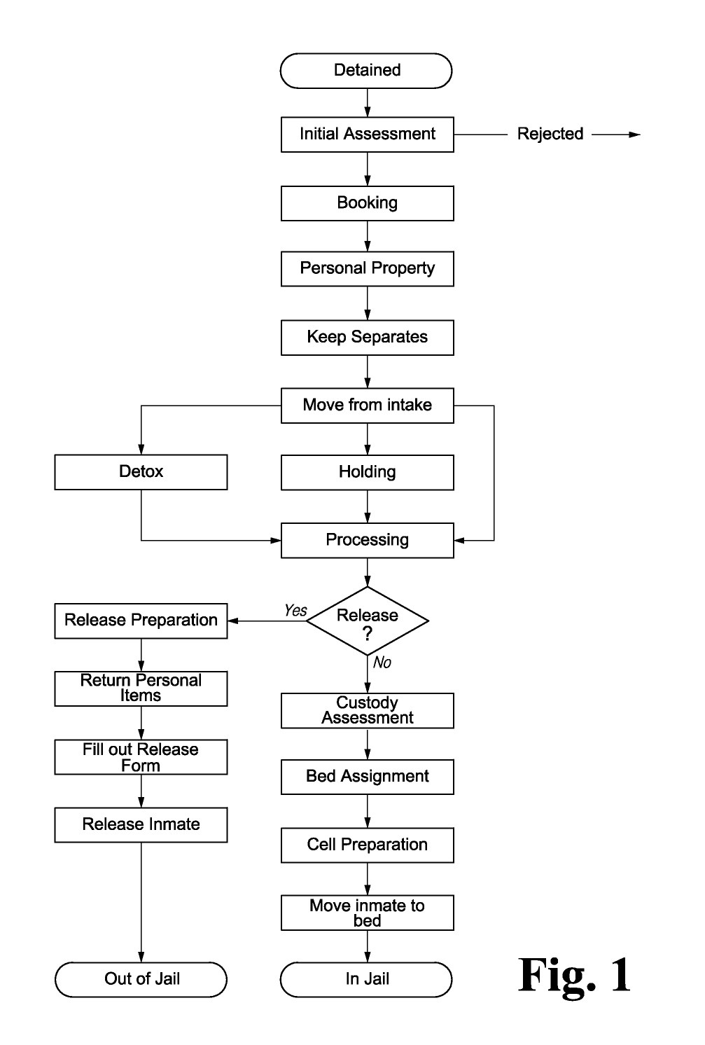

Wizard based processes are a big advantage in computer systems. They simplify design and training for the system. In the present invention, a wizard based approach is used for processes that have varying outcomes, such as initial assessments. The initial assessment process asks a series of questions that could cause the overall outcome path to change. For, example, if the detainee is a minor, then the questions are different than if they were an adult. A sample flow of a detainee into the facility is seen in FIG. 1.

The present invention also utilizes mobile technology to allow supervisors to check in on their facilities while on the go. The mobile dashboard is used by a supervisor to check on current detainee locations, transactions, and to check and address any outstanding alerts.

### SOFTWARE

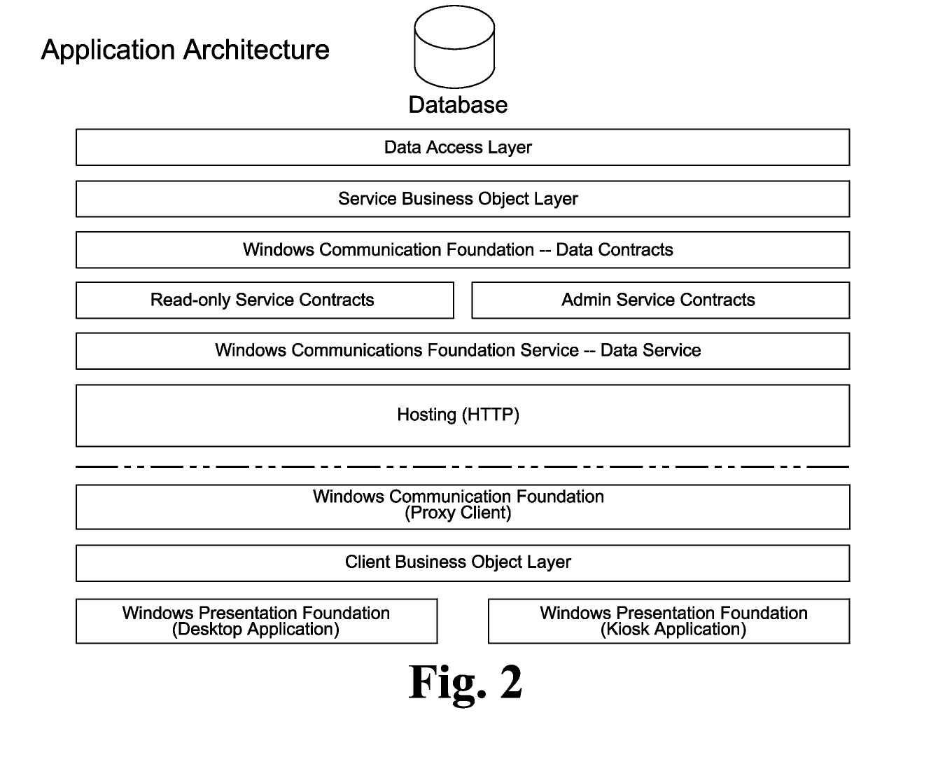

The present invention uses a client-server model, which creates greater interoperability amongst applications long term, and that combines several different hardware and software technologies. Data is housed in an SQL Server database and utilizes SQL Server Reporting Services along with SQL Server Analysis Services for reporting. The software is Microsoft .NET based, specifically C#, and utilizes several different architectural layers that can be seen in FIG. 2. Basically once compiled, the application breaks down into four separate components. Those components are a web service, alert service, desktop client, and a kiosk client.

The web service is built using Windows Communication Foundation Services, and is accessed utilizing HTTP protocol, Located within this service is a data access layer containing all methods required to access our SQL Server database, a business object/persistence layer that contains all business logic necessary for our objects, a data contract layer containing all our data transfer objects as well as any business object translators required, and all of our Windows Communication Foundation service contracts that allow our application to subscribe to the service.

The Alert service is a Windows based service that runs as a timed event. This service checks the database at a configurable amount of time to determine if any of the system business rules have been violated. The Alert service will send out a notification to individuals set in the system as an active supervisor.

The desktop client user interface is built using Windows Presentation Foundation and is layered similar to the web service. To access the service, a call is made to the proxy client layer. This layer also contains all data transfer object translators and translates them into the business object layer. The user interface for this application is geared more towards a normal desktop computer running Windows and is keyboard and mouse navigated.

The kiosk user interface is built utilizing the same technology, Windows Presentation Foundation, along with the same programming layers as the desktop. However, it is built to run on a touch screen driven kiosk. Navigation of the application is entirely geared toward touch as well as enhanced animation to enrich the staff member's experience.

All hardware used to run the application of the present invention has to run on the Microsoft Windows platform and can be either 32 or 64 bit compliant, The server must also have internet Information Service installed in order to run the web service application, Currently the desktop and kiosk version of the user interface will run on normal desktop machines. However, as stated above, the kiosk is optimized for a touch screen.

Wall mounted kiosks are placed at strategic locations throughout the facilities. These kiosks are touch-screen based, have a fingerprint scanner attached, and are ruggedized for a jail's environment. Currently, preformed kiosks are being built by SeePoint Technology, LLC., however, the present invention can certainly accommodate a different kiosk device.

The fingerprint readers attached to the kiosks are built by DigitalPersona, and the present invention also is using their Software Development Kit to interface with the scanner and to do print comparisons. The present invention also has modularized this in the software to allow the present invention to quickly change vendors should that need ever arise.

We claim:

1. A computer aided method of tracking persons who need to be tracked, comprising the steps of
providing means to biometrically identify and track the movements of person be tracked;
providing business rules and business rule monitoring to assure that persons tracked movements are completed correctly and timely;
providing wizard-based computer data entry of persons' tracking data;
providing alert notifications by e-mail and by text messaging relating persons being tracked;
providing cloud-based computer data sharing relating to persons being tracked;
providing mobile dashboard integration of data relating to persons being tracked; and
providing real-time transaction logging of persons' tracking data.

2. The computer aided method of claim 1 wherein the means to biometrically identify and track includes touch screen kiosks with attached fingerprint readers.

3. The computer aided method of claim 2 wherein photographs of persons to be tracked are provided on the touch screen kiosks.

4. The computer aided method of claim 3 wherein the business rules and business rule monitoring includes selecting where the tracked person is to be taken, with a movement transaction being created that shows who is being moved, where they are going, who is moving them, how long it has been since the movement transaction was started, and the identification of the location of he touch screen kiosk that was used to start the movement transaction.

5. The computer aided method of claim 4 wherein the business rules and business rule monitoring includes defined room classifications containing lists of persons being tracked that cannot be in the same rooms at the same time.

6. The computer aided method of claim 1 wherein the cloud-based computer data sharing stores information from all related facilities that have persons to track that is shared with all related facilities with persons to track.

7. The computer aided method of claim 4 wherein after the movement transaction is started, the person to be tracked is escorted to the location selected in the movement transaction where the escorter would log onto a touch screen kiosk located on a nearby wall, and re-fingerprint the person being tracked to validate the tracked person's arrival at the movement transaction end location.

8. The computer aided method of claim 7 wherein the alert notifications by e-mail and by text messaging are sent to supervisory personnel if the movement transaction end location escort login and re-fingerprinting of the person being tracked has not been occurred in an anticipated time period.

9. The computer aided method of claim 1 wherein the business rules and business rule monitoring includes task transactions for asks that are done periodically, which are noted as completed by logging onto a touch screen kiosk with notes of the task completed.
